(19) United States
(12) Patent Application Publication
(10) Pub. No.: US 2018/0307472 A1
(43) Pub. Date: Oct. 25, 2018

(54) SIMULTANEOUS DEPLOYMENT ON CLOUD DEVICES AND ON ON-PREMISE DEVICES

(71) Applicant: SAP SE, Walldorf (DE)

(72) Inventors: DHRUBAJYOTI PAUL, BANGALORE (IN); RAHUL LODHE, BANGALORE (IN); GANESH MOORTHY DURAISAMY, BANGALORE (IN)

(21) Appl. No.: 15/491,978

(22) Filed: Apr. 20, 2017

(51) Int. Cl. G06F 9/445; H04L 9/32; H04L 12/24

(52) U.S. Cl. CPC G06F 8/60; H04L 67/10; H04L 41/12; H04L 9/3263

(57) ABSTRACT

To simultaneously deploy software package on hosts such as cloud devices and on-premise device, a request is received at a central server to deploy a software package on hosts in a landscape. A topology file of the hosts in the landscape is generated. The hosts in the landscape include one or more hosts located in the cloud environment and one or more hosts located in the on-premise environment. A server side security certificate corresponding to the central server and host side security certificate corresponding to each of the hosts in the landscape is generated. The server side security certificate from the central server is sent to each of the hosts to establish a trusted communication between the central server and the hosts. Accordingly, the software package is deployed simultaneously on hosts as cloud devices and on-premise device.

### FIELD

Illustrated embodiments generally relate to data processing, and more particularly to simultaneous deployment of software applications on cloud and on on-premise devices.

### BACKGROUND

Typically, the computer landscapes of enterprises include group of devices or systems deployed in various logical tiers. Sometimes, the logical tiers may be located on cloud and on-premise to serve different purposes. For example, a logical tier of devices used for transactional or operational activities may be located on cloud, and a logical tier of devices/applications to host the data and data intensive logical operations are located on-premise. Some tiers of the landscape may be on the cloud, while some tiers of the landscape may be on-premise. When software is to be deployed in such an enterprise, the deployment needs to take place both on-premise and on cloud simultaneously. It is a challenge today to deploy software on multiple devices in multiple locations of landscapes simultaneously.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating environment for simultaneous deployment on hosts such as cloud devices and on-premise device, according to one embodiment.

FIG. 2 is a block diagram illustrating environment of landscape for simultaneous deployment on cloud and on on-premise devices, according to one embodiment.

FIG. 3A is a block diagram of environment illustrating exemplary use case of simultaneous deployment of software packages on cloud devices and on-premise devices, according to one embodiment.

FIG. 3B is an exemplary topology file illustrating topology of hosts in landscape, according to one embodiment.

FIG. 4A is a block diagram illustrating simultaneous deployment of software packages on hosts corresponding to various tiers in multi-tier environments, according to one embodiment.

FIG. 4B is an exemplary topology file illustrating topology of hosts corresponding to various tiers in a multi-tier environment in landscape, according to one embodiment.

FIG. 5 is a block diagram of patch forecaster in the landscape, according to one embodiment.

FIG. 6 is a flow chart, illustrating a process of simultaneous deployment on hosts such as cloud devices and on-premise devices according to one embodiment.

FIG. 7 is a block diagram illustrating an exemplary computer system, according to one embodiment.

### DETAILED DESCRIPTION

Embodiments of techniques for simultaneous deployment on cloud and on-premise devices are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”. “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

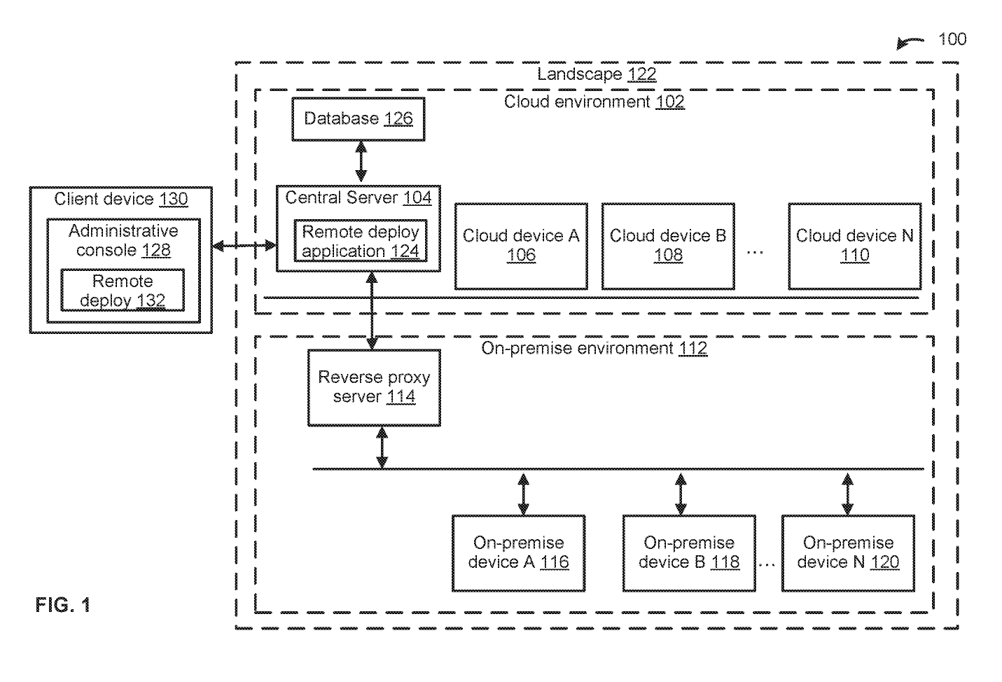

FIG. 1 is a block diagram illustrating environment 100 for simultaneous deployment on hosts such as cloud devices and on-premise devices, according to one embodiment. In cloud environment 102, hosts such as servers or datacenters referred to as cloud devices may be used to host applications and/or services for users. For example, the cloud environment 102 may include central server 104, and hosts such as cloud device A 106, cloud device B 108, cloud device N 110, etc. In an on-premise environment 112, hosts such as servers or computer systems such as mail server, web server, application server, etc., referred to as on-premise devices may be used to deploy enterprise applications. For example, the on-premise environment 112 may include reverse proxy server 114, and hosts such as on-premise device A 116, on-premise device B 118, on-premise device N 120, etc. On-premise devices and cloud devices include hardware components such as processor, hard disk drive, RAM, etc., and software components such as enterprise application packages, software framework packages, etc. Cloud Devices from cloud environment 102 such as central server 104, cloud device A 106, cloud device B 108, cloud device N 110, and on-premise devices from on-premise environment 112 such as reverse proxy server 114, on-premise device A 116, on-premise device B 118, on-premise device N 120, are considered as a single landscape 122. Landscape 122 includes hosts or devices in cloud environment 102 and in on-premise environment 112.

The cloud devices such as cloud device A 106, cloud device B 108 and cloud device N 110 are connected to central server 104. Remote deploy application 124 executing in the central server 104 enables simultaneous deployment of software packages on cloud devices and on-premise devices in the landscape 122. Simultaneous deployment refers to the process of deployment in parallel, or deployment on cloud devices and on-premise devices at a same instance of time without any delay. Software package may be combination of individual files or resources packaged together as a single entity. For example, a software package may be a combination of installation files, software patches, etc. The on-premise devices from on-premise environment 112 such as on-premise device A 116, on-premise device B 118, and on-premise device N 120, are connected to the central server 104 via the reverse proxy server 114. The reverse proxy server 114 retrieves resources from the central server 104 on behalf of the on-premise devices, and sends the resources to the on-premise devices. Data processed in the central server 104 may be stored in database 126. Remote deploy application 124 executing at the central server 104 manages simultaneous deployment of software packages on the cloud devices and on-premise devices in the landscape 122.

Administrative console 128 at client device 130 may be used to access the remote deploy application 124 executing at the central server 104. A tab/link/button ‘remote deploy’ 132 displayed in the administrative console 128 at the client device 130 may be used to initiate the simultaneous deployment on cloud and on-premise devices. When the tab or link ‘remote deploy’ 132 is clicked at the client device 130, the remote deploy application 124 executing at the central server 104 performs simultaneous deployment of software packages on cloud devices such as cloud device A 106, cloud device B 108 and cloud device N 110, and on-premise devices such as on-premise device A 116, on-premise device B 118 and on-premise device N 120. e

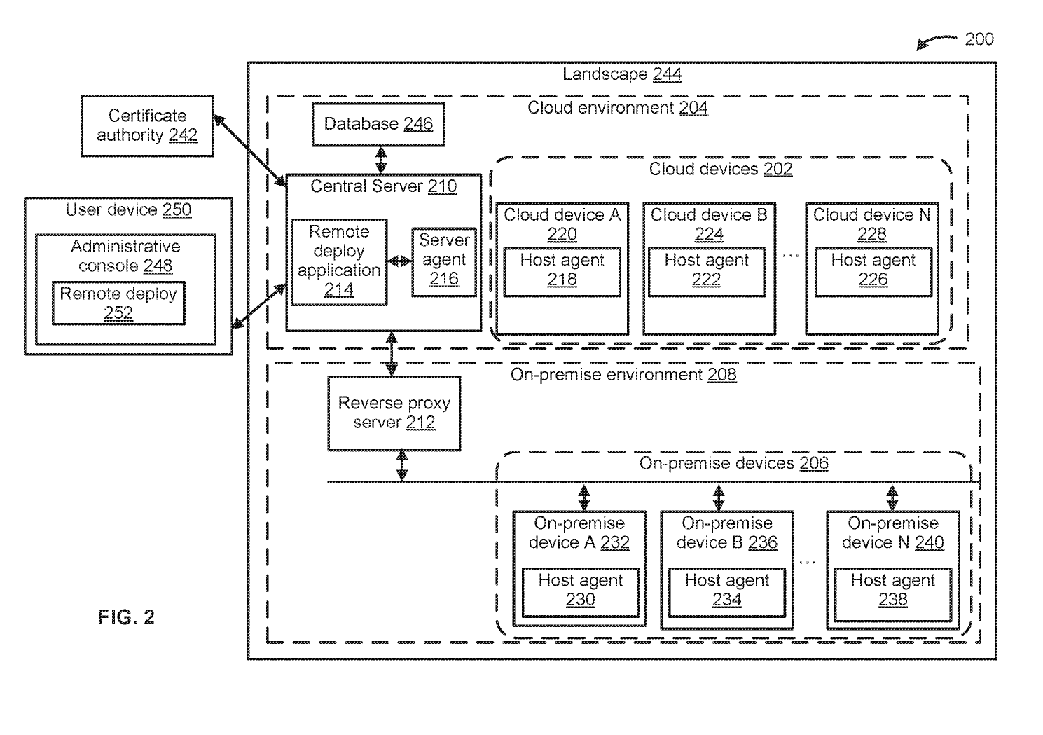

FIG. 2 is a block diagram illustrating environment 200 of landscape 244 for simultaneous deployment on cloud and on-premise devices, according to one embodiment. Cloud devices 202 in cloud environment 204, and on-premise devices 206 in on-premise environment 208 are connected to central server 210 by establishing secure communication such as hyper text transfer protocol secure (HTTP secure), etc. The on-premise devices 206 are connected to the central server 210 via reverse proxy server 212. When the secure communication is established, the remote deploy application 214 executing in central server 210 deploys server agent 216 on the central server 210, and host agents on the individual cloud devices such as host agent 218 on cloud device A 220, host agent 222 on cloud device B 224, and host agent 226 on cloud device N 228, and on on-premise devices such as host agent 230 on on-premise device A 232, host agent 234 on on-premise device B 236, and host agent 238 on on-premise device N 240. Server agent 216 is a software program or logic that enables the administrative tasks associated with the remote deploy application 214. Host agent is a software program or logic that extends the functionality of the remote deploy application 214 executing in the central server 210 to the cloud devices 202 and on-premise devices 206.

The server agent 216 communicates with the host agents on the cloud devices 202 and on-premise devices 206. The remote deploy application 214 executing in the central server 210 manages deployment of software packages on the cloud devices 202 and on-premise devices 206 through the server agent 216 and the host agents. Once the host agents are installed on the cloud devices 202 and the on-premise devices 206, security certificates are generated by certificate authority 242, and sent to the central server 210. The central server 210 is connected to the certificate authority by a secure communication network such as hypertext transfer protocol secure (HTTPS) network. The certificate authority 242 generates different security certificates such as host side security certificates and server side certificates for host server authentication. The server side security certificate and host side security certificates are generated based on a common signing certificate from the certificate authority 242. The common signing certificate from the certificate authority 242 enables mutual authentication of the server side security certificate in the central server 210 and host side security certificates in the host agents in the hosts such as cloud devices 202 and on-premise devices 206. The server side security certificate is configured in the central server 210. While configuring landscape 244, the central server 210 may push the host side security certificates to the individual host agents in the cloud devices 202 and on-premise devices 206. Once the host agents import the host side security certificates, the server agent 216 will initiate configuring the host side security certificates in the individual cloud devices and on-premise devices. The implementation of security certificate explained above is merely exemplary, however, there may be various other implementation of the security certificate.

While connecting the hosts such as cloud devices 202 and on-premise devices 206 to the central server 210, the topology of the landscape 244 is generated and stored in the central server 210. The topology is stored in an extensible markup language XML file format in the central server 210 in database 246. For example, the topology of the landscape 244 may include landscape name, environment e.g. mixed, cloud, on-premise, etc., device identifiers e.g. unique name assigned to the device, classification of the device e.g. web tier server, database tier server, etc., software deployed in the device e.g. version of the software application deployed, etc. Topologies of the cloud devices 202 and on-premise devices 206 are determined and stored in the central server 210. Administrative console 248 in user device 250 may be used to access the remote deploy application 214 executing in the central server 210.

User may choose a software package for deployment, and click on the link ‘remote deploy’ 252 displayed in the administrative console 248 in the user device 250. In response to clicking the link ‘remote deploy’ 252, the simultaneous deployment of the software package on the cloud devices 202 and the on-premise devices 206 is initiated from the server agent 216 in the central server 210. The server agent 216 refers to the topology file in the central server 210 to perform deployment on the cloud devices 202 and the on-premise devices 206.

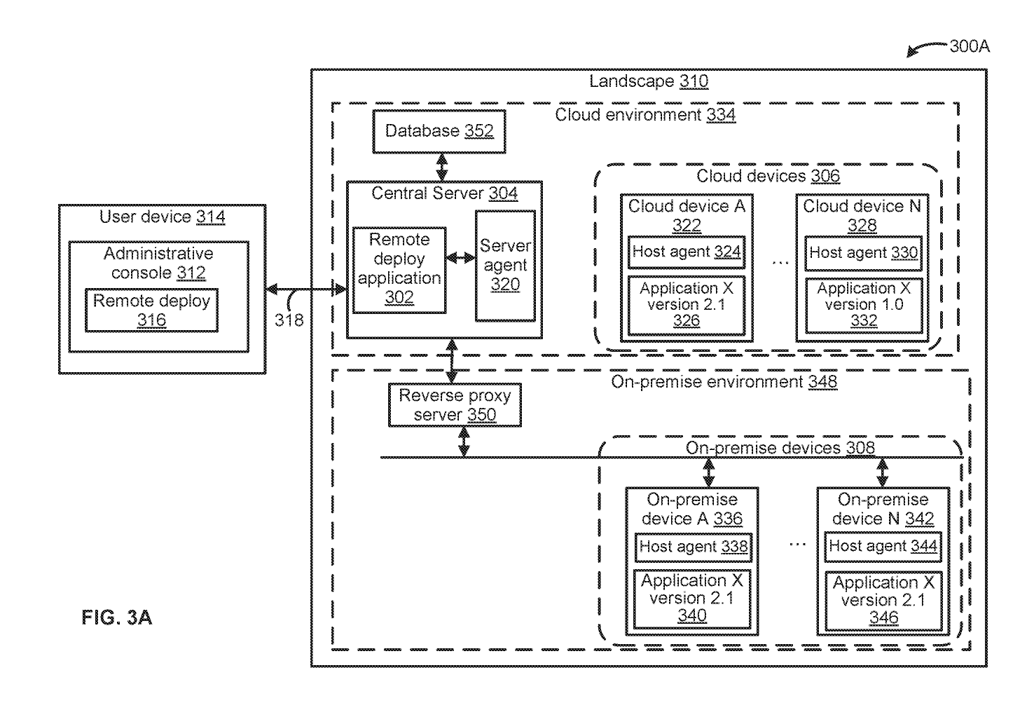

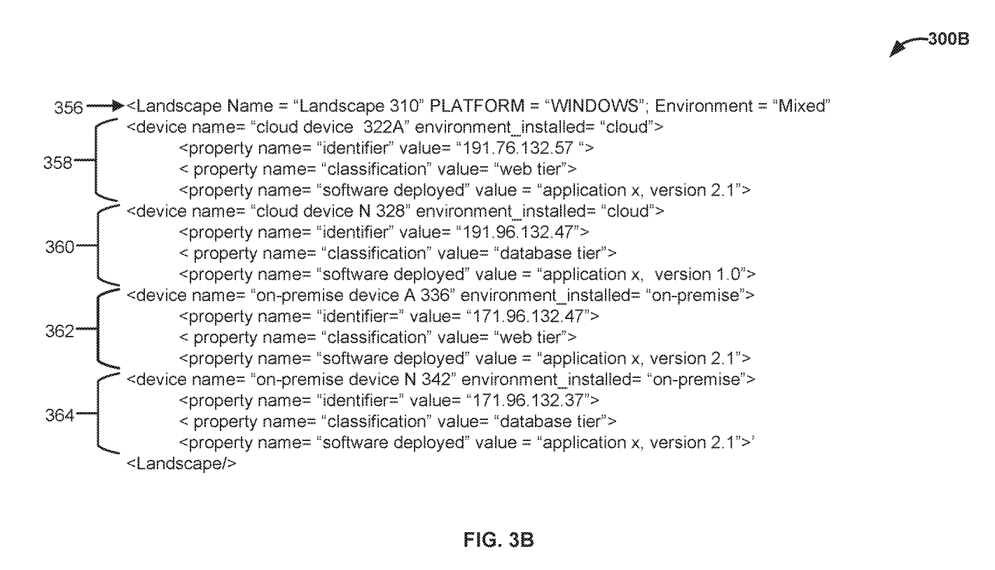

FIG. 3A is a block diagram of environment 300A illustrating exemplary use case of simultaneous deployment of software packages on cloud devices and on-premise devices, according to one embodiment. Remote deploy application 302 executing in central server 304 manages simultaneous deployment of software packages on hosts such as cloud devices 306 and on-premise devices 308 in single landscape 310. Administrative console 312 in user device 314 may be used to access the remote deploy application 302 executing in the central server 304. User may choose a software package for deployment, e.g. application X version 2.2 (not shown), and click on the link ‘remote deploy’ 316 displayed in the administrative console 312 in the user device 314. In response to clicking the link ‘remote deploy’ 316, the simultaneous deployment on the hosts such as the cloud devices 306 and the on-premise devices 308 is initiated as request 318 from the administrative console 312 in the user device 314. The request 318 is received at the remote deploy application 302 executing in the central server 304, and server agent 320 simultaneously deploys the software package on the hosts such as cloud devices 306 and on-premise devices 308. When the request 318 is received at the remote deploy application 302, a set of prerequisite checks is launched simultaneously to check for the latest version of software installations on the cloud devices 306 and on-premise devices 308.

The set of pre-requisite checks may also include checking whether the required software framework is installed on the cloud devices 306 and on-premise devices 308. For example, consider landscape 310 with cloud devices 306 such as cloud device A 322 with host agent 324 and application X version 2.1 326, and cloud device N 328 with host agent 330 and application X version 1.0 332. The hosts such as cloud devices 306 are located in the cloud environment 334. The on-premise devices 308 in the landscape 310 includes on-premise device A 336 with host agent 338 and application X version 2.1 340, and on-premise device N 342 with host agent 344 and application X version 2.1 346. The hosts such as on-premise device A 336 and on-premise device N 342 are located in the on-premise environment 348. The communication between the central server 304 and the on-premise devices 308 is via reverse proxy server 350. The data in the central server is stored in database 352.

The set of pre-requisite checks may include checking if application X version 2.1 is installed on the hosts such as the cloud device A 322, cloud device N 328, on-premise device A 336 and on-premise device N 342. Further, the set of pre-requisite checks may include checking whether software framework Z is installed on the cloud device A 322, cloud device N 328, on-premise device A 336 and on-premise device N 342. If the set of pre-requisite check is not met for some of the hosts or devices, a summary log of the result of the pre-requisite check is generated. Based on the summary log, the devices that did not meet the set of pre-requisite checks are identified, and appropriate actions are taken for those devices.

For example, when the set of pre-requisite checks is performed on cloud device A 322, cloud device N 328, on-premise device A 336 and on-premise device N 342, it is identified that cloud device N 328 has application X with version 1.0 332 and did not pass the pre-requisite checks. Further, the on-premise device N 342 is identified to not have the software framework Z installed, and hence on-premise device N 342 did not pass the pre-requisite checks. The devices that did not pass the pre-requisite checks are captured in the summary log along with the actions to be performed. For example, the summary log includes summary entry that cloud device N 328 has application X with version 1.0 332 along with action update version 2.1, where the update version 2.1 may be an active link that points to the repository of software versions. The summary log also includes that the on-premise device N 342 is missing the software framework Z installation along with action update framework Z, where the update framework Z may be an active link that points to the repository of software frameworks.

The remote deploy application 302 has the logic to automatically enable the server agent 320 to access the summary log and perform the action corresponding to summary entry. For example, the remote deploy application 302 enables the server agent 320 to access the summary entry indicating cloud device N 328 has application X with version 1.0 332 along with action update version 2.1, and perform the action automatically update version 2.1. Similarly, the remote deploy application 302 enables the server agent 320 to access the summary entry indicating on-premise device N 342 is missing the software framework Z installation along with action update framework Z, and perform the action automatically update software framework Z on the on-premise device N 342. A user may perform the actions in the summary log manually when the summary log is displayed in the administrative console 312 in the user device 314. Once the actions are performed successfully, the set of pre-requisite checks may be resumed from the point where it temporarily halted or stopped. When the pre-requisite checks are passed, simultaneous deployment of the software package e.g. application X version 2.2 is performed on hosts such as cloud devices 306 and on-premise devices 308.

Topology file 300B as shown in FIG. 3B of the landscape 310 stored in the central server 304 is used as a reference to perform the simultaneous deployment of software package e.g. application X version 2.2 on the cloud device A 322, cloud device N 328, on-premise device A 336 and on-premise device N 342. FIG. 3B is an exemplary topology file illustrating topology of hosts in landscape, according to one embodiment. To deploy the software package e.g. application X version 2.2 on cloud devices 306 and on-premise devices 308, the sequence of deployment depends on the software package or properties of the software package being deployed. For example, properties of the application X version 2.2 to be deployed on the cloud devices 306 and on-premise devices 308 determine that application X version 2.2 may be deployed in parallel or simultaneously on cloud devices 306 and on-premise devices 308. Server agent 320 refers to the topology file stored in the central server 304 to deploy application X version 2.2 on cloud devices 306 and on-premise devices 308.

The topology file indicates that landscape 310 supports mixed mode of deployment indicated by the environment parameter ‘mixed’ as shown in entry 356. Referring to the topology file application X version 2.2 is deployed in parallel or simultaneously on cloud device A 322 and on-premise device A 336, since the properties of application X version 2.2 support parallel deployment. While deployment, section 358 in the topology file is referred to and the identifier e.g. IP address of cloud device A 322 is determined as “191.76.132.57”, and classification of the device is determined as “web tier”. Based on this information, application X version 2.2 is deployed on the host such as cloud device A 322. Similarly, sections 362, 360 and 364 in the topology file is referred to and software package application X version 2.2 is deployed in parallel or simultaneously on the hosts such as on-premise device A 336, cloud device N 328 and on-premise device N 342.

Post installation, health checks of the cloud devices 306 and on-premise devices 308 is performed and pre-defined test cases are launched automatically. On successful completion of execution of the pre-defined test cases, a notification will be displayed in the administrative console 312 in the user device 314 that the deployment of software package application X version 2.2 is successful. In case the pre-defined test cases fail, an error code associated with the failed test case is checked in a knowledge database, and appropriate action is proposed to the user. The knowledge database may be an incident database or repository where all the software issues are maintained along with an active link to appropriate action corresponding to the incident or failed test case.

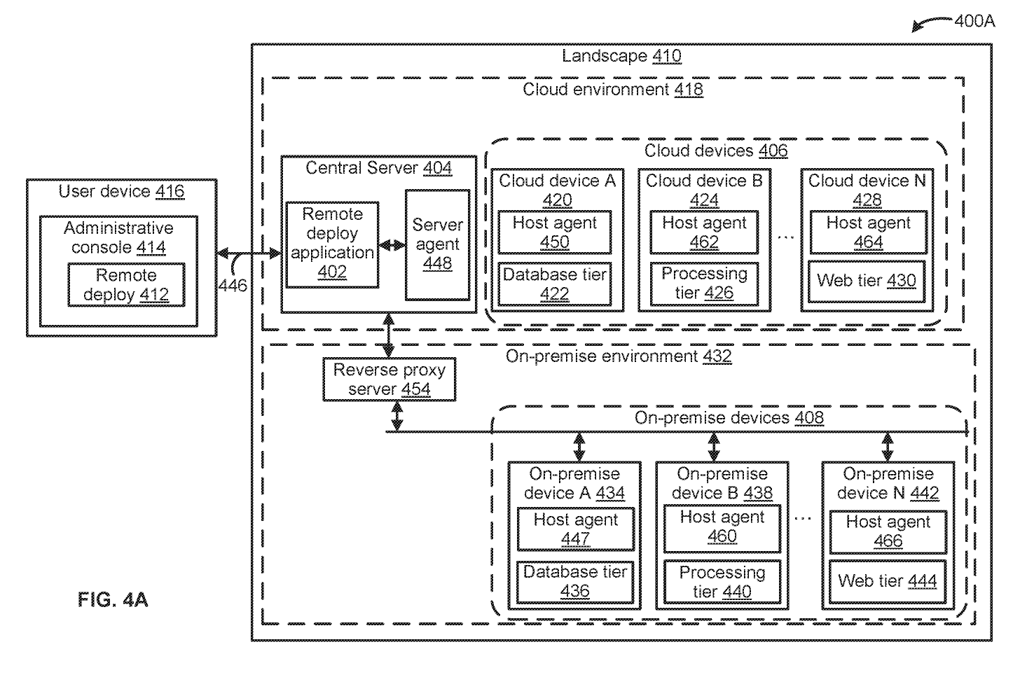

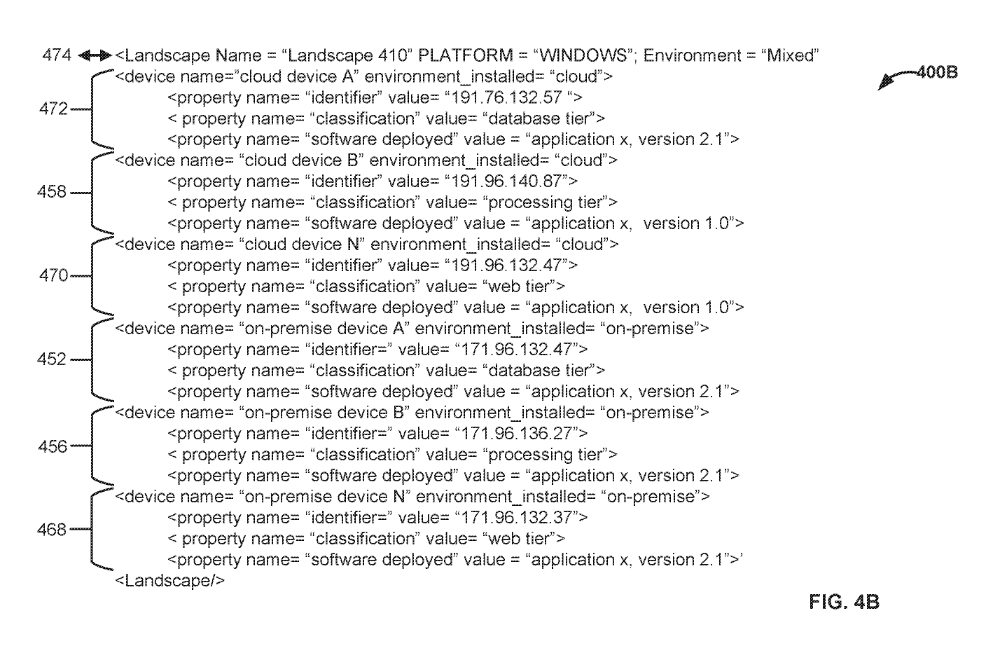

FIG. 4A is a block diagram 400A illustrating simultaneous deployment of software packages on hosts corresponding to various tiers in multi-tier environments, according to one embodiment. Remote deploy application 402 executing in central server 404 manages simultaneous deployment of software packages on hosts such as cloud devices 406 and on-premise devices 408 in landscape 410. Remote deploy 412 link in the administrative console 414 in user device 416 may be used to access the remote deploy application 402 executing in the central server 404. Cloud devices 406 referred to as hosts on the cloud environment 418 such as cloud device A 420 may be at database tier 422, cloud device B 424 may be at processing tier 426 and cloud device N 428 may be at web tier 430.

On-premise devices 408 referred to as hosts on the on-premise environment 432 such as on-premise device A 434 may be at database tier 436, on-premise device B 438 may be at processing tier 440, and on-premise device N 442 may be at web tier 444. The topology file 400B in FIG. 4B includes the device name, identifier may include the device identifiers e.g. unique identifier such as IP address assigned to the device, environment of the device e.g. cloud environment or on-premise environment, classification of the device e.g. web tier server, or database tier server, software deployed in the device e.g. version of the software application deployed, etc.

FIG. 4B is an exemplary topology file 400B illustrating topology of hosts corresponding to various tiers in a multi-tier environment in landscape, according to one embodiment. When a software package is received for deployment from the administrative console 414 in the user device 416, and remote deploy 412 is clicked. Based on this click, request 446 to deploy the software package is initiated by server agent 448 in the central server 404. The server agent 448 refers to sections 472 and 452 of the topology file 400B and identifies that cloud device A 420 and on-premise device A 434 are devices in the database tiers 422 and 436 respectively. The properties of the software package received for deployment determines the sequence of deployment in the hosts such as cloud devices 406 and on-premise devices 408. For example, properties of the software package may require that deployment occurs first on the host on the on-premise device in database tier, and then the deployment occurs on the host on the cloud device in database tier in a sequence. With the topology file as reference, server agent 448, initiates deployment on the on-premise device A 434 via host agent 447.

Communication from the central server 404 to the on-premise devices 408 is routed through reverse proxy server 454. The reverse proxy server 454 receives the software package from the central server 404 and sends it to the on-premise devices 408. The remote deploy application 402 enables the server agent 448 to stop the on-premise device A 434 referred to as the host in database tier 436, and deploy the software package on the on-premise device A 434, and automatically restart the on-premise device A 434. Stopping the device, deploying and restarting takes place automatically without human intervention. With the section 472 in the topology file as reference, server agent 448, initiates deployment on the cloud device A 420 in the database tier 422 via host agent 450. Post installation of the software package in database tier, the properties of the software package may support deployment of software package in parallel or simultaneously on on-premise device B 438 and cloud device B 424 in the processing tier. The server agent refers to sections 456 and 458 the topology file 400B and deploys the software packages on the on-premise device B 438 and cloud device B 424 in the processing tier. Accordingly, the software deployment is performed in parallel or simultaneously on the on-premise device B 438 and cloud device B 424. The remote deploy application 402 enables the server agent 448 to deploy the software package in parallel or simultaneously on the on-premise device B 438 in the processing tier 440 via host agent 460, and the cloud device B 424 in the processing tier 426 via host agent 462.

Post installation of the software package in the processing tier, the properties of the software package may support deployment of software package in parallel or simultaneously on on-premise device N 442 and cloud device N 428 in the web tier. Once the deployment is completed in the processing tier, deployment is automatically initiated in the web tier devices. The server agent 448 communicates with the host agent 464 on the cloud device N 428 and host agent 466 on the on-premise device N 442, and deploys the software packages in parallel on the on-premise device N 442 and cloud device N 428 in the web tier. The server agent refers to sections 468 and 470 the topology file 400B and deploys the software packages on the on-premise device N 442 and cloud device N 428 in the web tier. The deployment is performed in parallel or simultaneously on hosts corresponding to various tiers of the landscape 410.

In one embodiment, the simultaneous deployment may be in cloud mode, on-premise mode or mixed mode. While connecting the cloud devices and on-premise devices to the central server, remote deploy application determines the topology of the landscape and generates a topology file. If the topology file indicates that landscape 410 supports mixed mode i.e. cloud mode and on-premise mode of deployment, it is indicated by the environment parameter ‘mixed’. For example, in topology file 400B the environment parameter ‘mixed’ is shown in the section 474. If the topology file indicates that landscape 410 supports cloud mode of deployment, it is indicated by the environment parameter ‘cloud’. If the topology file indicates that landscape 410 supports on-premise mode of deployment, it is indicated by the environment parameter ‘on-premise’. Depending on the topology of the landscape corresponding mode of deployment takes place.

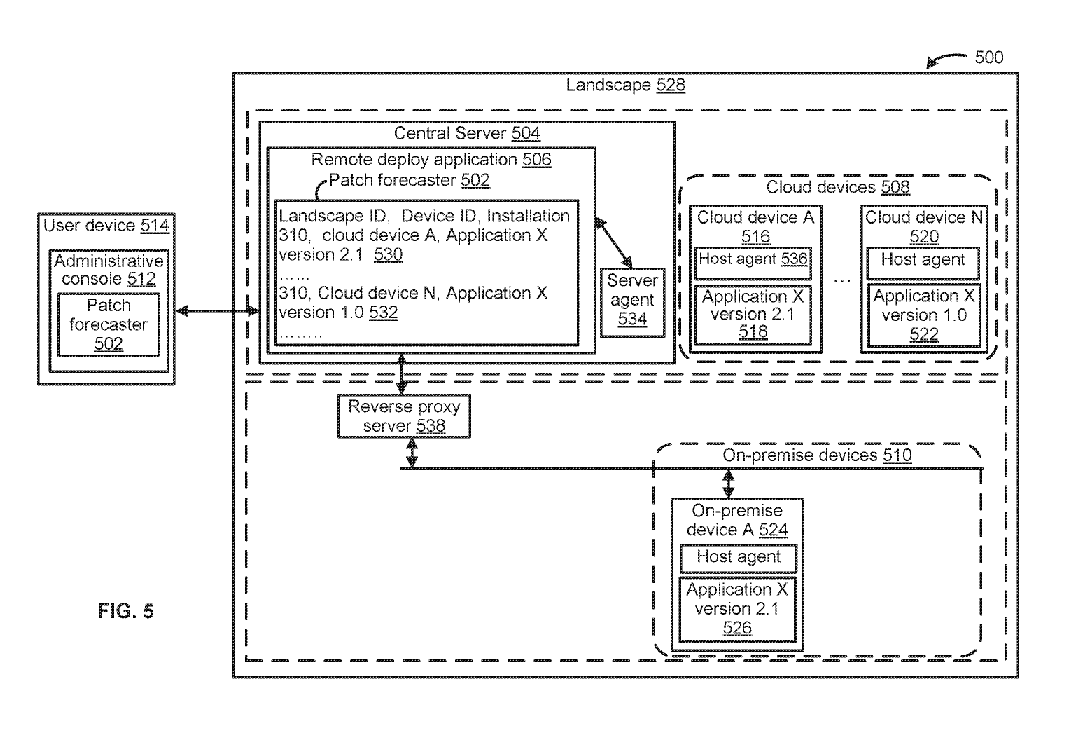

FIG. 5 is block diagram 500 of patch forecaster in the landscape, according to one embodiment. Patch forecaster 502 in the central server 504 in the remote deploy application 506 manages an inventory of list of software applications/software patches and/or hotfixes installed on hosts such as cloud devices 508 and on-premise devices 510, along with the version information of the software applications installed on the cloud devices 508 and on-premise devices 510. The list of patches and/or hotfixes and version information of compiled program files of the installed software applications on the individual cloud devices 508 and on-premise devices 510 is displayed in administrative console 512. The patch forecaster 502 matches the version information of each patch or software installed on the individual cloud devices 508 and on-premise devices 510 with the version information of the new patch released for that software application. Based on the match, the patch forecaster 502 provides recommendation to a user whether the new version of patch released will be useful to install immediately, or to wait until the next version of patch is released.

The patch forecaster automatically runs this match on a periodic basis, and provides this information as a pop up in the administrative console 512 in the user device 514. For example, the patch forecaster 502 may provide several information on the administrative console such as: (a) the number of days the landscape was not updated. (b) the new version of patch released can be skipped and wait for a further version of patch release, (c) upcoming release of a next service pack and the number of days for release, (d) release of new version of patch and the link to download, etc. When the pop up of new version of patch and the link to download is displayed in the administrative console 512 in the user device 514, user may choose to initiate download and install of the new version of patch from the administrative console 512. Accordingly, patch forecaster 502 enables automated monitoring of the patches on individual cloud devices 508 and on-premise devices 510 in a single administrative console 512 thereby eliminating monitoring the devices individually. For example, cloud device A 516 may have application X version 2.1 518 installed, cloud device N 520 may have application X version 1.0 522 installed, and on-premise device A 524 may have application X version 2.1 526 installed.

The list of devices and the software versions installed on various hosts or devices in the landscape 528 is stored in the patch forecaster 502. For example, list in the patch forecaster 502 includes entry 530 with landscape id i.e. 310, device id i.e. cloud device A, and installation id i.e. Application X version 2.1. Similarly, the list includes entry 532 with landscape id i.e. 310, device id i.e. cloud device N, and installation id i.e. Application X version 1.0. The patch forecaster automatically matches the list of software applications installed along with version information installed on the hosts such as cloud devices and on-premise devices with the new version of software released. For example, if a new version 2.3 is released for the application X, the patch forecaster may match this new release application X version 2.3 with the list of software installations in the patch forecaster. Based on the match, patch forecaster may recommend that the new version of patch released can be skipped and wait for a further version of patch release. The recommendation may be displayed in the administrative console 512 in the user device 514. In one embodiment, if the patch forecaster recommends installation of the software application X version 2.3, server agent 534 communicates with the host agent 536 on the cloud device A 516 to install the software application X version 2.3. Similarly, the software application X version 2.3 may be installed on other cloud and on-premise devices as well. Communication between the central server 504 and the on-premise devices 510 is via reverse proxy server 538.

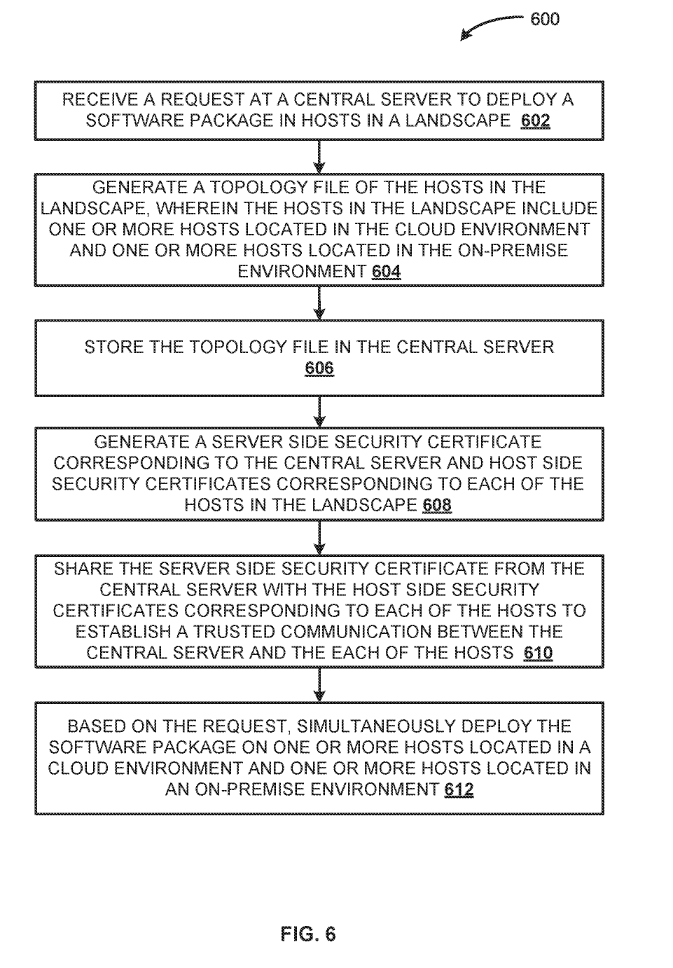

FIG. 6 is a flow chart 600, illustrating a process of simultaneous deployment on hosts such as cloud devices and on-premise devices, according to one embodiment. At 602, a request is received at a central server to deploy a software package on hosts in a landscape. At 604, a topology file of the hosts in the landscape is generated. The hosts in the landscape include one or more hosts located on the cloud environment and one or more hosts located on the on-premise environment. At 606, the topology file is stored in the central server. At 608, a server side security certificate corresponding to the central server and host side security certificates corresponding to each of the hosts in the landscape are generated. At 610, the server side security certificate from the central server is sent to each of the hosts to establish a trusted communication between the central server and the hosts. At 612, based on the request, the software package is simultaneously deployed on the one or more hosts located on a cloud environment and the one or more hosts located on an on-premise environment.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media: and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

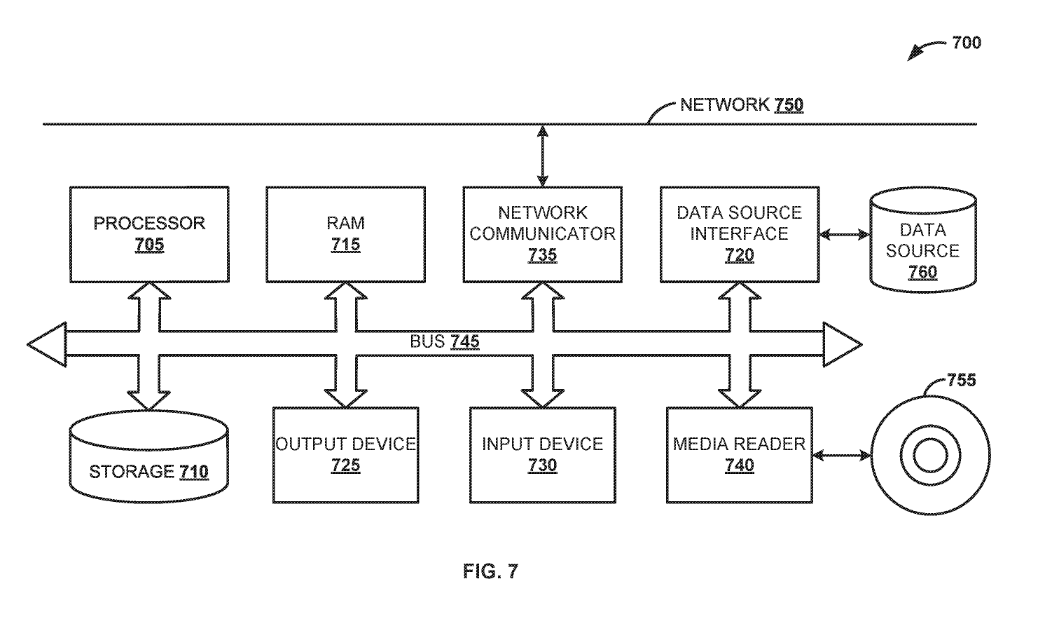

FIG. 7 is a block diagram of an exemplary computer system 700. The computer system 700 includes a processor 705 that executes software instructions or code stored on a computer readable storage medium 755 to perform the above-illustrated methods. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive a request at a central server to deploy a software package in hosts in a single landscape, wherein the hosts in the single landscape includes one or more hosts located on a cloud environment and one or more hosts located on an on-premise environment; and
based on the request, simultaneously deploy the software package in the single landscape including the one or more hosts located on the cloud environment and the one or more hosts located on the on-premise environment.

2. The non-transitory computer-readable medium of claim 1, further comprises instructions which when executed by the computer further cause the computer to:
generate a topology file of the hosts on the landscape, wherein the hosts in the landscape include the one or more hosts located on the cloud environment and the one or more hosts located on the on-premise environment; and
store the topology file in the central server.

3. The non-transitory computer-readable medium of claim 1, further comprises instructions which when executed by the computer further cause the computer to:
generate a server side security certificate corresponding to the central server and host side security certificates corresponding to each of the hosts in the landscape; and
send the server side security certificate from the central server to each of the hosts to establish a trusted communication between the central server and the hosts.

4. The non-transitory computer-readable medium of claim 1, further comprises instructions which when executed by the computer further cause the computer to:
at the central server, receive selection of the software package and the request to remote deploy the software package from an administrative console in a user device;
in response to the request, initiate simultaneous deployment of the software package by a server agent in the central server; and
using a topology file of the landscape as reference, the server agent in the central server, simultaneously deploy the software package on the hosts in the landscape using host agents.

5. The non-transitory computer-readable medium of claim 4, further comprises instructions which when executed by the computer further cause the computer to:
using the topology file of the landscape as reference, the server agent in the central server, simultaneously deploy the software package on hosts in a first tier using the host agents; and
using the topology file of the landscape as reference, the server agent in the central server, deploy in sequence the software package on the hosts in a second tier using the host agents.

6. The non-transitory computer-readable medium of claim 1, further comprises instructions which when executed by the computer further cause the computer to:
perform a pre-requisite check to determine whether the hosts in the landscape meet the pre-requisite check;
generate a summary log with details of the hosts that did not meet the pre-requisite check along with actions; and
automatically perform the actions corresponding to the hosts.

7. The non-transitory computer-readable medium of claim 1, further comprises instructions which when executed by the computer further cause the computer to:
store in a patch forecaster in the central server a list of software packages and corresponding versions deployed on the hosts in the landscape;
automatically match the list of software packages and corresponding versions with a new version of a software package release; and
in response to the match, automatically notify a user of with matched information.

8. A computer-implemented method of simultaneous deployment on cloud devices and on-premise devices, the method comprising:
receiving a request at a central server to deploy a software package on hosts in a single landscape, wherein the hosts in the single landscape includes one or more hosts located on a cloud environment and one or more hosts located on an on-premise environment; and
based on the request, simultaneously deploying the software package in the single landscape including the one or more hosts located on the cloud environment and the one or more hosts located on the on-premise environment.

9. The method of claim 8, further comprising:
generating a topology file of the hosts in the landscape, wherein the hosts in the landscape include the one or more hosts located on the cloud environment and the one or more hosts located on the on-premise environment; and
storing the topology file in the central server.

10. The method of claim 8, further comprising:
generating a server side security certificate corresponding to the central server and host side security certificates corresponding to each of the hosts in the landscape; and sending the server side security certificate from the central server to each of the hosts to establish a trusted communication between the central server and the hosts.

11. The method of claim 8, further comprising:
at the central server, receiving selection of the software package and the request to remote deploy the software package from an administrative console in a user device;
in response to the request, initiate simultaneous deployment of the software package by a server agent in the central server; and
using a topology file of the landscape as reference, the server agent in the central server, simultaneously deploying the software package on the hosts in the landscape using host agents.

12. The method of claim 11, further comprising:
using the topology file of the landscape as reference, the server agent in the central server, simultaneously deploying the software package on hosts in a first tier using the host agents; and
using the topology file of the landscape as reference, the server agent in the central server, deploying in sequence the software package on the hosts in a second tier using the host agents.

13. The method of claim 8, further comprising:
performing a pre-requisite check to determine whether the hosts in the landscape meet the pre-requisite check;
generating a summary log with details of the hosts that did not meet the pre-requisite check along with actions; and
automatically performing the actions corresponding to the hosts.

14. The method of claim 8, further comprising:
storing in a patch forecaster in the central server a list of software packages and corresponding versions deployed on the hosts in the landscape;
automatically matching the list of software packages and corresponding versions with a new version of a software package release; and
in response to the match, automatically notifying a user of with matched information.

15. A computer system for simultaneous deployment on cloud devices and on-premise devices, comprising:
a computer memory to store program code; and
a processor to execute the program code to:
receive a request at a central server to deploy a software package on hosts in a single landscape, wherein the hosts in the single landscape includes one or more hosts located on a cloud environment and one or more hosts located on an on-premise environment; and
based on the request, simultaneously deploy the software package in the single landscape including the one or more hosts located on the cloud environment and the one or more hosts located on the on-premise environment.

16. The system of claim 15, wherein the processor further executes the program code to:
generate a topology file of the hosts in the landscape, wherein the hosts in the landscape include the one or more hosts located on the cloud environment and the one or more hosts located on the on-premise environment; and
store the topology file in the central server.

17. The system of claim 15, wherein the processor further executes the program code to:
generate a server side security certificate corresponding to the central server and host side security certificates corresponding to each of the hosts in the landscape; and
send the server side security certificate from the central server to each of the hosts to establish a trusted communication between the central server and the hosts.

18. The system of claim 15, wherein the processor further executes the program code to:
at the central server, receive selection of the software package and the request to remote deploy the software package from an administrative console in a user device;
in response to the request, initiate simultaneous deployment of the software package by a server agent in the central server; and
using a topology file of the landscape as reference, the server agent in the central server, simultaneously deploy the software package on the hosts in the landscape using host agents.

19. The system of claim 18, wherein the processor further executes the program code to:
using the topology file of the landscape as reference, the server agent in the central server, simultaneously deploy the software package on hosts in a first tier using the host agents; and
using the topology file of the landscape as reference, the server agent in the central server, deploy in sequence the software package on the hosts in a second tier using the host agents.

20. The system of claim 15, wherein the processor further executes the program code to:
store in a patch forecaster in the central server a list of software packages and corresponding versions deployed on the hosts in the landscape;
automatically match the list of software packages and corresponding versions with a new version of a software package release, and
in response to the match, automatically notify a user of with matched information.
